(19) United States
(12) Patent Application Publication
(10) Pub. No.: US 2008/0006597 A1
(43) Pub. Date: Jan. 10, 2008

(54) Bottle vent system

(76) Inventor: John Samson, Swansea, IL (US)

Correspondence Address: SUNG I. OH, PROFESSIONAL LAW CORPORATION, 710 QUAIL VALLEY LANE, WEST COVINA, CA, 91791, US

(21) Appl. No.: 11/481,784

(22) Filed: Jul. 6, 2006

(51) Int. Cl. A61J 9/04

(52) U.S. Cl. 215/11.5

(57) ABSTRACT

A vent system for a bottle such as baby bottle or a sports drink bottle that is easily opened and closed. The vent system is built into the wall of the bottle and includes an air port through the wall and a plug that closes and opens the port by operation of the bottle user. When the vent system is open, air can flow into the bottle to prevent clogging and when the system is closed, the bottle is secure against leakage or invasion of bacteria or the like.

### TECHNICAL FIELD OF THE INVENTION

The present invention relates to the general art of liquid containers, and to the particular field of liquid containing and dispensing bottles.

### BACKGROUND OF THE INVENTION

A common problem generally associated with fluid dispensing bottles, such as sports drink bottles, water bottles, nursing baby bottles, or the like, is the presence of air in the bottle which air can be the cause of gas, coughing, or other gastric intestinal disturbances. For example, in a conventional nursing bottle having rigid side walls both formula and air are present and are thus ingested by the feeding infant, which feels discomfort and distress to the presence of air in its stomach.

In previous designs, feeding bottles comprised a bottle main body and a nipple. Conventional bottle is often made of plastic material, while the nipple is made of silicon rubber which is relatively soft and can be twisted or curled. In early designs, there was only one opening provided on the nipple within the whole structure for sucking purpose. However, since the bottle was a completely enclosed chamber, the nipple often became deformed as a result of pressure difference. This resulted in a non-continuous flow of milk from the nipple opening so that the infant had to stop sucking for a while to let the nipple recover to its initial state. To a little baby, this is a significant problem.

In response to the above-discussed problems, an improved structure has been developed which comprises an one-way inward opening at the lower portion of the nipple. When a baby sucks on the nipple, air may flow in through said opening so that sucking can proceed continuously. However, the aforementioned structure allows for a direct contact between said opening and milk. Consequently, coagulated milk fat often accumulated and blocked the opening. Thus, said opening lost its function of adjusting the pressure and the good effect of said structure is seriously compromised and curtailed. The reason that the small opening provided on the nipple gets clogged up is that the opening is not easily cleaned and therefore, residual milk fat may remain lodged around the opening. Furthermore, there is direct contact between milk and air when said structure is utilized. The dirt in air may contaminate the milk and bubbles exist in the milk as well. These bubbles (i.e., air) and dirt may get into the body of the infant, and thus result in an undesirable effect on the health of the infant. Obviously, said feeding bottle structure has many drawbacks.

Accordingly, the development of nursing bottles included designs comprising thin-walled shells adapted to enclose a flexible liner which functions as the formula container was intended to alleviate if not completely eliminate the problem of air ingestion. It was believed that as formula was drawn from the flexible liner the side walls of the liner would collapse about the remaining formula, thereby avoiding the creation of a partial vacuum within the bottle such as occurs in those bottles having rigid sides. It has been determined, however, that air will still be drawn into a nursing bottle having a flexible liner, especially after the contents are partially drawn out and the bottle is turned upright. Although the side walls of the liner do collapse, the tension exerted on the side walls by the weight of the formula at the bottom of the liner tends to separate the collapsed side walls, which generates a partial vacuum within the liner that draws air.

As has been discussed above, the problem associated with the presence of air in the bottle being used to deliver fluid to an infant is generally associated with a conventional baby nursing bottles and has been somewhat solved by the usage of flexible liner baby nursing bottles of the general type in which a flexible liner is supported by a cylindrical, open ended shell body and a nipple which holds the liner to the shell. One such type is commonly known as the “Playtex baby nurser” manufactured by the Playtex Corporation. These nursing baby bottles have become widely used and accepted because the flexible liner decreases in volume as the infant feeds thereby permitting the infant to receive formula or other liquids without sucking in air.

Baby nursing bottles, such as the above-referenced type, initially require that air in the chamber formed by the nipple and the liner cavity be expelled manually prior to the start of feeding. One typical and common method of expelling air is for the user to insert his or her fingers into the open end of the shell body and push on the liner until all of the air is expelled and only liquid remains in the liner and nipple portion. While air may be expelled in this manner for a full bottle, as the amount of liquid in the bottle diminishes the liner must be pushed further into the shell from the open lower end of the shell body until the user's fingers can no longer reach the liner to compress the liner and liquid contained therein to expel any captured air.

Another common problem generally associated with flexible liner baby nursing bottles is the reentry of air into the liner after the bottle has been put aside, particularly in an upright position such as might be the case when the baby is being burped or otherwise attended to. The weight of the liquid in the liner tends to pull the liner downward drawing air into the liner through the nipple. Air may also be drawn into the liner when the baby stops sucking for a period of time since the vacuum created by the sucking is removed.

One attempt to solve the problem of air reentry is the use of a mating cap that contacts or compresses the nipple to form a seal. However, the mating cap seldom works efficiently which allows air to reenter the liner of the baby nursing bottle and requires that a user interrupt the infant feeding to attempt to expel the air once again. Additionally, the mating cap does not solve the problem of expelling air which already exists in the liner, its difficulty and usage during the infant feeding process and must generally be sterilized prior to use since it comes into contact with the nipple of the bottle.

It is desirable therefore to provide apparatus and a related method for use with a flexible liner baby nursing bottle which generally overcomes the problems of expelling air from the bottle described above.

While problems associated with baby bottles have been detailed above, similar problems exist for adults using sports drink bottles. Therefore, while baby bottles have been discussed above, no limitation to baby bottles is intended and the scope of this disclosure is intended to include sports drink bottles as well.

### SUMMARY OF THE INVENTION

The above-discussed disadvantages of the prior art are overcome by a vent system for a liquid dispensing bottle that is easily opened and closed. The plug is mounted on one end of a lever with a finger-operated pad on the other end of the lever. The lever is mounted on the bottle in the manner of a first class lever so that when the pad is pushed toward the wall of the bottle, the plug moves away from covering relationship with the air port. A spring can be included that biases the lever in a direction that moves the plug into a port covering position. If a spring is not included, the plug can be sized to frictionally engage the bottle adjacent to the port to remain engaged with the bottle until the lever is actuated. When the vent system is open, air can flow into the bottle to prevent clogging and when the system is closed, the bottle is secure against leakage or invasion of bacteria or the like.

Using the vent system embodying the present invention will permit a user to vent his or her bottle as required for smooth flow of liquid, but will keep the bottle closed at other times.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a baby bottle with the vent system embodying the present invention, with the vent system being covered.

FIG. 2 is a perspective view of a baby bottle with the vent system embodying the present invention, with the vent system being uncovered.

FIG. 3 is a side elevational view of the vent system embodying the present invention.

### DETAILED DESCRIPTION OF THE INVENTION

Referring to the figures, it can be understood that the present invention is embodied in a bottle vent system 10 which assists the contents of a bottle to flow freely. System 10 which comprises a bottle 12 which has a first end 14 which is a fluid dispensing end when the bottle is in use and which can have a dispenser element, such as nipple 16, thereon, a second end 18 which is a base end, and a longitudinal axis 20 which extends between first end 14 and second end 18.

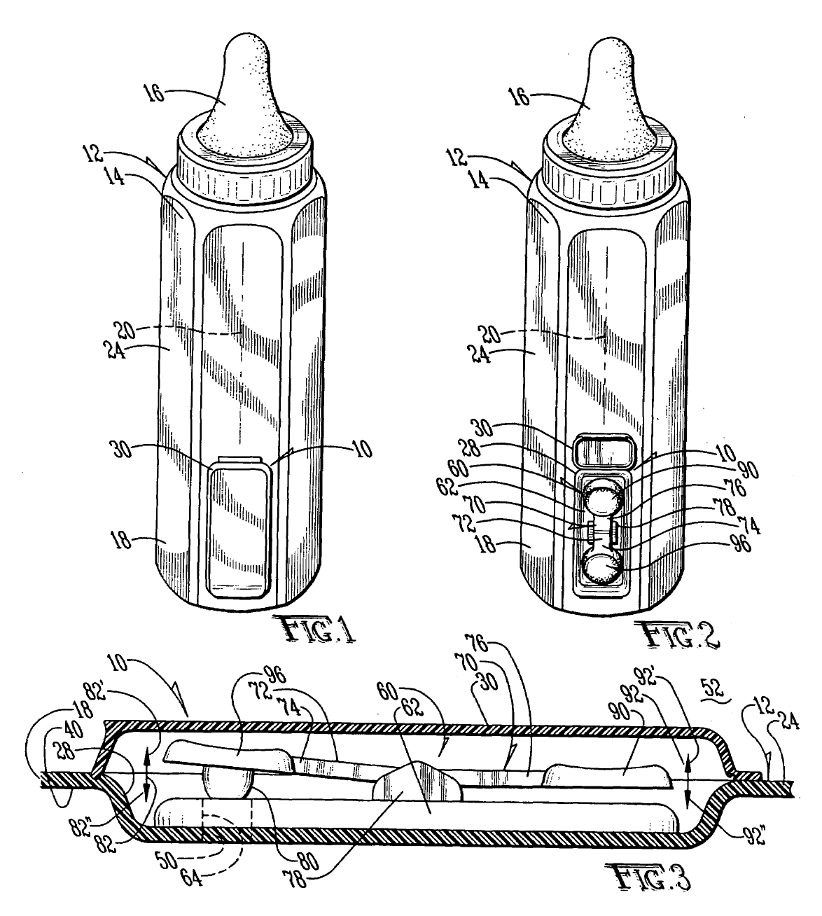

A side wall 24 connects first end 14 to second end 18. A cutout portion 28 is defined in the side wall, and a cover 30 is releasably mounted on the side wall in covering relationship to the cutout portion when the cover is in place on the side wall as shown in FIG. 1. A fluid-accommodating chamber 40 is defined in the bottle and contains fluids such as baby formula, milk, water, sports drinks or the like.

An air port 50 is defined through the side wall, and fluidically connects fluid-accommodating chamber 40 to ambient conditions 52 surrounding the bottle whereby ambient pressure is transferred to chamber 40 via port 50. In the form shown, the air port is located adjacent to second end 18 of the bottle. An air port controlling unit 60 is mounted on the side wall of the bottle adjacent to the air port. Air port controlling unit 60 includes a base 62 mounted on the side wall of the bottle in covering relationship to the air port. A bore 64 is defined through the base. Bore 64 is in fluid communication with air port 50 to fluidically connect fluid-accommodating chamber 40 to the ambient conditions via the air port and the bore.

A bore-occluding unit 70 is mounted on base 62 and includes a V-shaped lever 72 of the first class. Lever 72 has a first end 74 and a second end 76. First end 74 is positioned adjacent to bore 64. A fulcrum 78 is mounted on base 62 and supports the lever between first end 74 and second end 76 so the lever pivots about the fulcrum in the manner of a first class lever.

A plug 80 is located on the first end of the lever. As indicated by double-headed arrow 82, plug 80 moves in directions 82′ and 82″ between a bore-occluding position when the lever is in a first position and a bore-uncovering position when the lever is in a second position. In one form of the invention, the plug is frictionally held in the bore-occluding position by frictional engagement of plug 80 in bore 64.

A finger-engageable pad 90 is located on second end 76 of the lever. As indicated by double-headed arrow 92, pad 90 moves between a first position 92′ located spaced apart from base 62 and a second position 92″ located closely adjacent to base 62. The first position of the pad corresponds to the bore-occluding position of the plug and the second position of the pad corresponding to the bore-uncovering position of the plug.

Accordingly, moving the finger-engageable pad in direction 92″ from the first position thereof into the second position thereof moves the plug in direction 82′ out of the bore-occluding position and opens the fluid-accommodating chamber to ambient conditions. Use of the bottle vent system can be understood from the teaching of the foregoing. Cover 30 is removed, and pad 90 is pushed in direction 92″ to expose chamber 40 to ambient pressure and fluid is dispensed from the bottle. When fluid dispensing is completed, pad 80 is pushed in direction 82″ into bore-occluding position to close bore 64 and port 50. In one form of the invention, a finger pad 96 is mounted on lever 72 adjacent to plug 80 to facilitate movement in direction 82″. As mentioned above, while the figures show a baby bottle, it is intended that the scope of this disclosure includes a sports drink bottle as well and the baby bottle is shown in the figures for convenience and not for limitation.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A bottle vent system comprising:
A) a bottle having
(1) a first end which is a fluid dispensing end when the bottle is in use,
(2) a second end,
(3) a longitudinal axis which extends between the first end and the second end,
(4) a side wall which connects the first end to the second end,
(5) a cutout portion defined in the side wall,
(6) a cover that is releasably mounted on the side wall in covering relationship to the cutout portion when the cover is in place on the side wall, and
(7) a fluid-accommodating chamber defined in the bottle;
B) an air port defined through the side wall, the air port fluidically connecting the fluid-accommodating chamber to the ambient conditions surrounding the bottle;
C) an air port controlling unit mounted on the side wall of the bottle adjacent to the air port, the air port controlling unit including
(1) a base mounted on the side wall of the bottle in covering relationship to the air port,
(2) a bore defined through the base, the bore being in fluid communication with the air port to fluidically connect the fluid-accommodating chamber to the ambient conditions via the air port and the bore,
(3) a bore-occluding unit which is mounted on the base and which includes
(a) a lever of the first class having a first end and a second end, the first end of the lever being positioned adjacent to the bore,
(b) a fulcrum mounted on the base and supporting the lever between the first end of the lever and the second end of the lever so the lever moves about the fulcrum,
(c) a plug on the first end of the lever, the plug moving between a bore-occluding position when the lever is in a first position and a bore-uncovering position when the lever is in a second position,
(d) a finger-engageable pad on the second end of the lever, the pad moving between a first position located spaced apart from the base and a second position located closely adjacent to the base, with the first position of the pad corresponding to the bore-occluding position of the plug and the second position of the pad corresponding to the bore-uncovering position of the plug,
(e) whereby moving the finger-engageable pad from the first position thereof into the second position thereof moves the plug out of the bore-occluding position and opens the fluid-accommodating chamber to ambient conditions.

2. The bottle vent system defined in claim 1 wherein the air port is located adjacent to the second end of the bottle.

3. The bottle vent system defined in claim 2 wherein the bottle is a baby bottle.

4. The bottle vent system defined in claim 1 wherein the lever is V-shaped.

5. The bottle vent system defined in claim 1 further including a finger pad mounted on the lever adjacent to plug of the bore-occluding unit.
